(19) United States
(12) Patent Application Publication
(10) Pub. No.: US 2024/0097389 A1
(43) Pub. Date: Mar. 21, 2024

(54) PORTABLE WIRE CRIMPING SYSTEM

(71) Applicant: ELECTRICAL COMPONENTS INTERNATIONAL, INC., St. Louis, MO (US)

(72) Inventor: Andrew Frame, Webster, NY (US)

(21) Appl. No.: 18/367,221

(22) Filed: Sep. 12, 2023

Related U.S. Application Data
(60) Provisional application No. 63/407,882, filed on Sep. 19, 2022.

(51) Int. Cl. H01R 43/042

(52) U.S. Cl. CPC H01R 43/0428; H01R 4/18

(57) ABSTRACT

A portable crimping system includes a portable crimper that has a head mounted to a body. The head is configured to include crimping dies that are configured to crimp a terminal to at least one wire. A stand includes at least one support that is removably secured to the portable crimper to support the portable crimper with the head oriented in a fixed working position. The stand includes an unsecured configuration in which the portable crimper is removable for crimping operations off of the stand.

### CROSS-REFERENCE TO RELATED APPLICATIONS

This disclosure claims priority to U.S. Provisional Patent Application No. 63/407,882 filed Sep. 19, 2022.

### TECHNICAL FIELD

This disclosure relates to a portable wire crimper and a customized stand for the same.

### BACKGROUND

In the production of wiring harnesses for various applications, a dedicated bench-top wire crimper is typically used. As the name implies, the bench-top devices are designed to remain on a tabletop during use and are not portable. One example bench-top crimper is available from Schleuniger (e.g., the CT34 pneumatic crimping machine).

In operation, an end or ends of one or more wires is inserted into a wire terminal. The wire terminal is placed within a space provided between open crimping dies of the wire crimper. The crimping machine is actuated to close the dies about the terminal, thus crimping the terminal to the wire(s). A typical bench-top crimper is relatively expensive and requires significant lead time and maintenance.

Portable crimpers are also used in some applications. The portable wire crimpers are handheld devices having a handle with a trigger and a power source. An operator is able to move the portable crimper feely about the work environment. One example portable crimper is available from Greenlee (e.g., Gator 12-ton crimping tool EK1230L120).

### SUMMARY

In one exemplary embodiment, a portable crimping system includes a portable crimper that has a head mounted to a body. The head is configured to include crimping dies that are configured to crimp a terminal to at least one wire. A stand includes at least one support that is removably secured to the portable crimper to support the portable crimper with the head oriented in a fixed working position. The stand includes an unsecured configuration in which the portable crimper is removable for crimping operations off of the stand.

In a further embodiment of any of the above, the portable crimper includes a power supply that is mounted to the housing and configured to remain operable with the portable crimper in the unsecured configuration.

In a further embodiment of any of the above, the body includes a collar that is mounted to a housing. The head is mounted to the collar. The at least one support is removably secured about the collar.

In a further embodiment of any of the above, the head is pivotally supported by the collar and is configured to permit rotation of the head relative to the body.

In a further embodiment of any of the above, the at least one support includes front and back members that are removably secured to one another with fasteners to provide a secured position that defines an aperture that receives the collar. The at least one support encircles the collar in the fixed working position.

In a further embodiment of any of the above, the head includes a hole, and the at least one support includes a fastener that extends through the hole.

In a further embodiment of any of the above, the at least one support includes a pair of laterally spaced apart members that are arranged on opposing sides of the head, and the fastener is secured to the laterally spaced apart members.

In a further embodiment of any of the above, the body includes a housing. The at least one support includes front and back members that are removably secured to one another with fasteners to provide a secured position that defines an aperture that receives the housing. The at least one support encircles the housing in the fixed working position.

In a further embodiment of any of the above, the front and back members respectively include front and back portions that are in overlapping relationship in the secured position.

In another exemplary embodiment, a stand for a portable crimper has a head mounted to a body. The head includes a hole. The head is configured to include crimping dies that are configured to crimp a terminal to at least one wire that includes a base plate, first and second side plates that are laterally spaced from one another and secured to the base plate, a first support that has first front and back members that are removably secured to one another with first fasteners to provide a secured position that defines a first aperture that is configured to receive the body. The first support is configured to encircle the body in a fixed working position in which the portable crimper is removably secured in the stand. The first back member laterally bridges and is secured to the first and second side plates. A second support includes a second fastener that is configured to extend through the hole.

In a further embodiment of any of the above, the aperture is circular. The aperture is configured to receive a collar of the body.

In a further embodiment of any of the above, the stand includes a third support that has third front and back members that are removably secured to one another with third fasteners to provide a secured position that defines a third aperture that is configured to receive the body. The third support is configured to encircle the body in the fixed working position. The third back member laterally bridges and is secured to the first and second side plates.

In a further embodiment of any of the above, the third support is configured to receive in the third aperture a housing of the body. The third front and back members respectively include front and back portions that are in overlapping relationship in the secured position.

In a further embodiment of any of the above, the second support includes a pair of laterally spaced apart members that are configured to be arranged on opposing sides of the head, and the second fastener is secured to the laterally spaced apart members in the fixed working position.

In a further embodiment of any of the above, the stand includes front and back braces that are each laterally bridged and secured to the first and second side plates.

In another exemplary embodiment, a method of operating a portable crimper, includes the steps of providing a stand that has first and second side plates that are laterally spaced from one another and secured to a base plate, the stand includes first and second supports, removably securing the first support about a portable crimper body, removably securing the second support about a portable crimper head, and crimping a terminal to at least one wire with the crimper head mounted in the stand.

In a further embodiment of any of the above, the step of removably securing the second support about a portable crimper head includes inserting a fastener through a hole in the portable crimper head.

In a further embodiment of any of the above, the stand includes a pair of laterally spaced apart members, and the step of removably securing the second support about a portable crimper head includes positioning the portable crimper head between the laterally spaced apart members and inserting the fastener into the laterally spaced apart members.

In a further embodiment of any of the above, the portable crimper body includes a collar that is mounted to a housing, and the portable crimper head is mounted to the collar. The step of removably securing the first support about a portable crimper body includes securing the first support about the collar, and includes a step of removably securing a third support about the housing.

In a further embodiment of any of the above, the method includes a step of actuating a trigger on a handle of the portable crimper body to perform the crimping step.

### BRIEF DESCRIPTION OF THE DRAWINGS

The disclosure can be further understood by reference to the following detailed description when considered in connection with the accompanying drawings wherein:

FIG. 1 is a perspective view of a portable crimping system including a portable crimper mounted to a stand to provide a fixed working position.

FIG. 2 is a perspective view of an example portable crimper, which is shown in FIG. 1.

FIG. 3 is a perspective view of the stand shown in FIG. 1 without the portable crimper mounted thereto.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

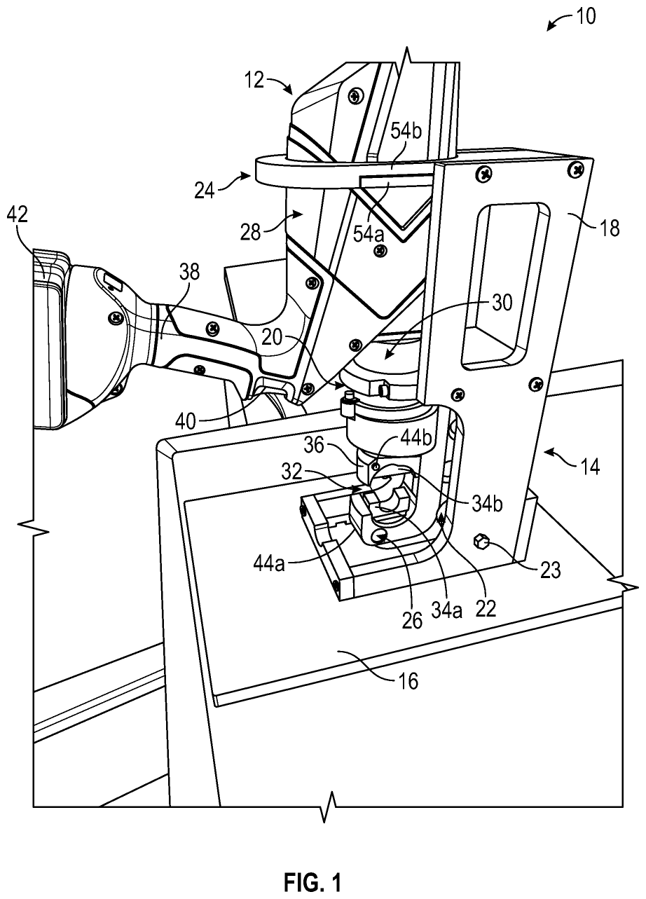

A portable crimping system 10 is shown in FIG. 1 and includes a portable crimper 12 removably mounted to a stand 14 or fixture. The portable crimper 12 is a handheld device intended for mobile use by an operator in a work environment. This same portable crimper 12 can also be used with the disclosed stand to provide an inexpensive yet robust bench-top-type crimping machine.

The stand 14, which may be constructed from aluminum plate, includes a base plate 16 to which laterally spaced apart side plates or uprights 18 are secured (using fasteners 52, not shown). In the example, three supports are used to removably secure the portable crimper 12 to the stand 14. It should be understood that fewer or more supports may be used depending upon the application.

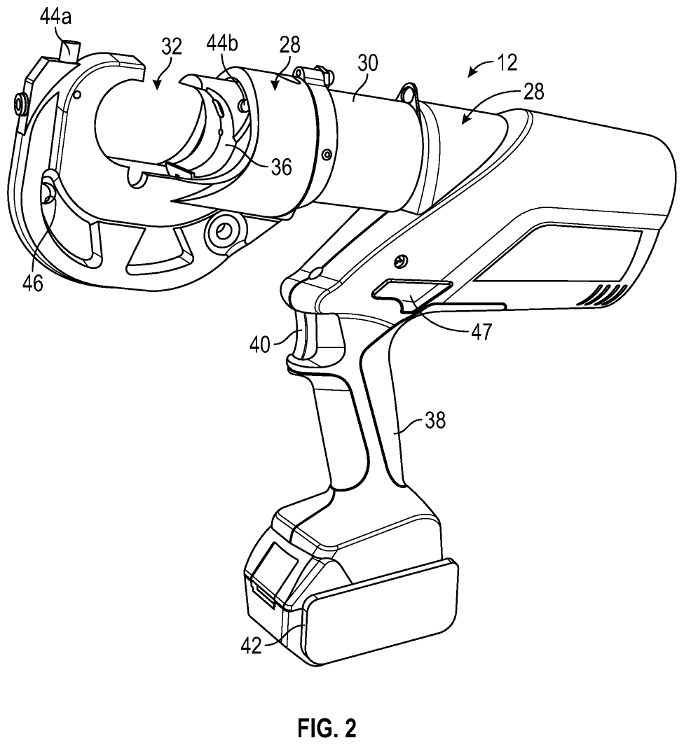

Portable crimper 12 includes a body comprising a housing 28 and a collar 30, which supports a head 26. The head 26 has an opening 32 with crimping dies 34a, 34b between which the terminal to be crimped is arranged. A ram 36 supports the crimping die 34a and is advanced to engage the terminal to crush the terminal about the wire(s) to provide a desired electrical connection (e.g., high voltage wire applications). Different sized crimping dies may be selected based upon the terminal and wire configuration. The crimping dies 34a, 34b are removable secured to the ram 36 and head 26 by release pins 44a, 44b, respectively (FIG. 2).

Since the portable crimper 12 is used as a portable device, the housing 28 has a handle 38 that can be grasped by the operator. The handle 38 includes a trigger 40 for advancing the ram 36 and a retract button 47 (FIG. 2) for retracting the ram 36, if needed. A power source 42 is provided on the body, for example, at a terminal end of the handle 38. The power source 42 may be a battery or an adapter that can be connected to 110 AC voltage.

The stand 14 includes first, second and third supports 20, 22, 24 that removably secure the portable crimper 12 and orient the head 26 securely in a fixed working position suitable for a bench-top-type production environment. However, the stand 14 also enables the portable crimper 14 to be easily removed when unsecured from the stand 14 for use in crimping operations off of the stand and in a manner conventional to typical portable crimpers 12. The power supply 42 can remain mounted to the portable crimper 12 both in the stand 14 and out of the stand 14 to remain operable seamlessly. The portable crimper 12 requires no modifications in order to be used with the stand 14, in the disclosed example.

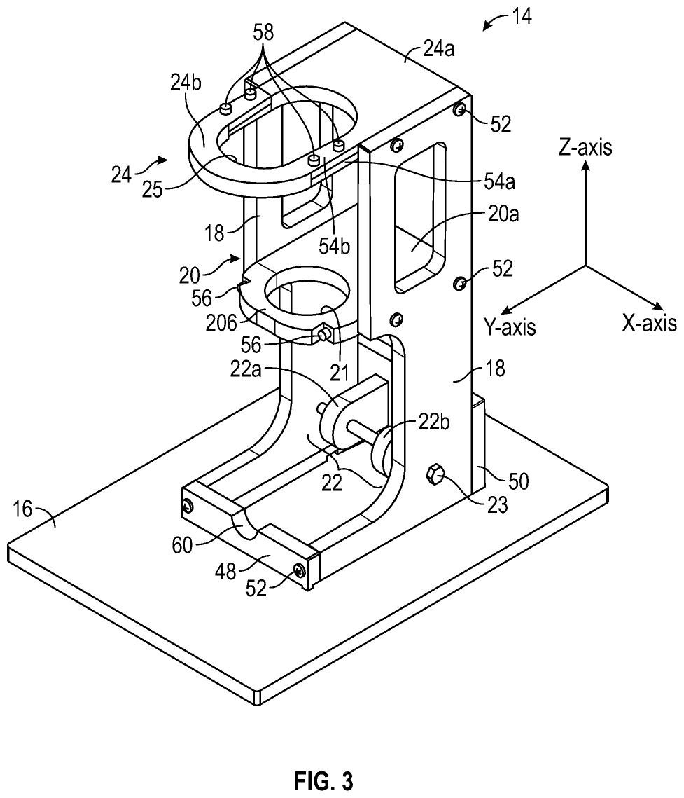

The collar 30 may retain the head in a fixed position with respect to the housing 28. With some portable crimpers 12, the head 26 is pivotable with respect to the collar 30 such that it may be oriented at different angular positions with respect to the handle 38. In the example stand 14 shown in FIG. 3, the first support 20 is removably secured about the collar (see, FIG. 1). The first support 20 includes front and back members 20a, 20b that form an aperture 21 receiving the collar 30 when removably secured about the portable crimper 12 using fasteners 56 arranged in the Y-direction.

As shown in FIG. 2, the head 26 of the portable crimper 12 is typically provided with a hole 46 for hanging the portable crimper 12 from a hook during storage. In the example, the second support 22 is provided by first and second laterally spaced apart members 22a, 22b that laterally locate the head 26 (shown in FIG. 1) when installed in the stand 14. The second support 22 also includes a fastener 23, such as a bolt, that is received in the hole 46 to locate the head 26 in the Y- and Z-directions. In one example, the laterally spaced apart members 22a, 22b each have unthreaded hole receiving the bolt. One of the side plates 18 has a threaded hole to receive the threaded end of the bolt, and the other hole in the side plate 18 is unthreaded, as shown in FIG. 3. During the installation, the bolt is slid along the X-direction through the hole in one side plate 18, through the hole in member 22b, into the hole 46, through the hole in member 22a, and then threaded into the hole in the other side plate 18.

The first and second supports 20, 22 may provide sufficient fixation of the portable crimper 12 within the stand 14. To locate the housing 28, particularly if the head 26 is rotatable, a third support 24 is arranged about the housing 28 (FIG. 1). The third support 24 includes front and back members 24a, 24b providing an aperture 25 that receives the housing 28. The first and second members 24a, 24b provide overlapping, interlocking features 54 that are secured by fasteners 58 extending in the Z-direction.

Front and back braces 48, 50 may be secured to the side plates 18 and/or the base plate 16 by fasteners 52 to provide additional structural rigidity to the stand 14. A clearance notch 60 may be provided in the front brace 48 to accommodate the head 26 in an orientation of 180° from the orientation shown in FIG. 1.

In operation, a method of operating the portable crimper 12 includes providing a stand 14 having the side plates 18 laterally spaced from one another and secured to the base plate 16. The stand 14 includes first and second supports, which may be any two of the three described supports 20, 22, 24, for example. The portable crimper body is removably secured using a support, e.g., first support 20. The portable crimper head 26 is removably secured using another support, e.g., second support 22. With the portable crimper 12 removably secured in the stand 14 in a bench-top-type configuration, a terminal is crimped to at least one wire with the crimper head 26 mounted in the stand 14. The portable crimper 12 is actuated using the trigger 40 on the handle 38 to advance the ram 36 and close the dies 34a, 34b about the terminal in the same manner as the portable crimper 12 would be used in an unmounted configuration in which the portable crimper 12 is removed and unsecure with respect to the stand 14.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A portable crimping system comprising:
a portable crimper having a head mounted a body, the head is configured to include crimping dies configured to crimp a terminal to at least one wire; and
a stand including at least one support that is removably secured to the portable crimper to support the portable crimper with the head oriented in a fixed working position, the stand includes an unsecured configuration in which the portable crimper is removable for crimping operations off of the stand.

2. The system of claim 1, wherein the portable crimper includes a power supply mounted to the housing and configured to remain operable with the portable crimper in the unsecured configuration.

3. The system of claim 1, wherein the body includes a collar mounted to a housing, and the head is mounted to the collar, the at least one support is removably secured about the collar.

4. The system of claim 3, wherein the head is pivotally supported by the collar and is configured to permit rotation of the head relative to the body.

5. The system of claim 3, wherein the at least one support includes front and back members removably secured to one another with fasteners to provide a secured position defining an aperture that receives the collar, the at least one support encircling the collar in the fixed working position.

6. The system of claim 1, wherein the head includes a hole, and the at least one support includes a fastener that extends through the hole.

7. The system of claim 6, wherein the at least one support includes a pair of laterally spaced apart members arranged on opposing sides of the head, and the fastener is secured to the laterally spaced apart members.

8. The system of claim 1, wherein the body includes a housing, the at least one support includes front and back members removably secured to one another with fasteners to provide a secured position defining an aperture that receives the housing, the at least one support encircling the housing in the fixed working position.

9. The system of claim 8, wherein the front and back members respectively include front and back portions that are in overlapping relationship in the secured position.

10. A stand for a portable crimper having a head mounted to a body, the head includes a hole, the head is configured to include crimping dies configured to crimp a terminal to at least one wire, comprising:
a base plate;
first and second side plates laterally spaced from one another and secured to the base plate;
a first support having first front and back members removably secured to one another with first fasteners to provide a secured position defining a first aperture that is configured to receive the body, the first support configured to encircle the body in a fixed working position in which the portable crimper is removably secured in the stand, the first back member laterally bridging and secured to the first and second side plates;
a second support includes a second fastener that is configured to extend through the hole.

11. The stand of claim 10, wherein the aperture is circular, the aperture configured to receive a collar of the body.

12. The stand of claim 11, comprising a third support having third front and back members removably secured to one another with third fasteners to provide a secured position defining a third aperture that is configured to receive the body, the third support configured to encircle the body in the fixed working position, the third back member laterally bridging and secured to the first and second side plates.

13. The stand of claim 12, wherein the third support is configured to receive in the third aperture a housing of the body, wherein the third front and back members respectively include front and back portions that are in overlapping relationship in the secured position.

14. The stand of claim 10, wherein the second support includes a pair of laterally spaced apart members configured to be arranged on opposing sides of the head, and the second fastener is secured to the laterally spaced apart members in the fixed working position.

15. The stand of claim 10, comprising front and back braces each laterally bridging and secured to the first and second side plates.

16. A method of operating a portable crimper, comprising the steps of:
providing a stand having first and second side plates laterally spaced from one another and secured to a base plate, the stand including first and second supports;
removably securing the first support about a portable crimper body;
removably securing the second support about a portable crimper head; and
crimping a terminal to at least one wire with the crimper head mounted in the stand.

17. The method of claim 16, wherein the step of removably securing the second support about a portable crimper head includes inserting a fastener through a hole in the portable crimper head.

18. The method of claim 17, wherein the stand includes a pair of laterally spaced apart members, and the step of removably securing the second support about a portable crimper head includes positioning the portable crimper head between the laterally spaced apart members and inserting the fastener into the laterally spaced apart members.

19. The method of claim 16, wherein the portable crimper body includes a collar mounted to a housing, and the portable crimper head is mounted to the collar, the step of removably securing the first support about a portable crimper body includes securing the first support about the collar, and the comprising a step of removably securing a third support about the housing.

20. The method of claim 16, comprising a step of actuating a trigger on a handle of the portable crimper body to perform the crimping step.
